(19) United States
(12) Patent Application Publication
(10) Pub. No.: US 2003/0054291 A1
(43) Pub. Date: Mar. 20, 2003

(54) Optical data storage medium containing a hemicyanine dye as the light-absorbing compound in the information layer

(76) Inventors: Horst Berneth, Leverkusen (DE); Friedrich-Karkl Bruder, Krefeld (DE); Wilfried Haese, Odenthal (DE); Rainer Hagen, Leverkusen (DE); Karin Hassenruck, Dussreldorf (DE); Serguei Kostromine, Swisttal (DE); Peter Landenberger, Koln (DE); Rafael Oser, Krefeld (DE); Thomas Sommermann, Bergisch Gladbach (DE); Josef-Walter Stawitz, Odenthal (DE); Thomas Bieringer, Odenthal (DE)

Correspondence Address: BAYER CORPORATION, PATENT DEPARTMENT, 100 BAYER ROAD, PITTSBURGH, PA, 15205, US

(21) Appl. No.: 10/102,282

(22) Filed: Mar. 20, 2002

(30) Foreign Application Priority Data
Mar. 28, 2001 (DE) 10115227.2
Apr. 6, 2001 (DE) 10117462.4
Jul. 25, 2001 (DE) 10136064.9

(51) Int. Cl. G11B 7/24

(52) U.S. Cl. 430/270.15

(57) ABSTRACT

An optical data storage medium containing a preferably transparent substrate which has optionally already been coated with one or more reflecting layers and onto the surface of which a photorecordable information layer, optionally one or more reflecting layers, and optionally a protective layer or an additional substrate or a top layer are applied, which data storage medium can be recorded on and read using blue or red light, preferably laser light, wherein the information layer contains a light-absorbing compound and optionally a binder, characterized in that at least one hemicyanine dye is used as the light-absorbing compound.

The invention relates to a preferably once recordable optical data storage medium containing a hemicyanine dye as the light-absorbing compound in the information layer, and to a process for its production.

Recordable optical data storage media using special light-absorbing substances or mixtures thereof are particularly suitable for use in high-density recordable optical data storage media which operate with blue laser diodes, and in particular GaN or SHG laser diodes (360-460 nm), and/or for use in DVD-R or CD-R discs, which operate with red (635-660 nm) or infrared (780-830 nm) laser diodes, and the application of the abovementioned dyes to a polymer substrate, in particular polycarbonate, by spin-coating or vapour deposition.

There has recently been an enormous growth in the sales of recordable compact discs (CD-R, 780 nm), which represent the technically established system.

The next generation of optical data storage media—DVDs—is currently being introduced onto the market. By using shorter-wave laser radiation (635 to 660 nm) and a higher numerical aperture NA, the storage density can be increased. The recordable format is in this case the DVD-R.

Today, optical data storage formats which use blue laser diodes (based on GaN, JP 08191171 or Second Harmonic Generation SHG JP 09050629) (360 nm to 460 nm) with a high laser power, are being developed. Recordable optical data storage media will therefore also be used in this generation . The achievable storage density depends on the focussing of the laser spot in the information plane. The spot size is proportional to the laser wavelength λ/NA. NA is the numerical aperture of the objective lens used. The aim is to use the smallest possible wavelength λ for obtaining the highest possible storage density. Based on semiconductor laser diodes, 390 nm are presently possible.

The patent literature describes dye-based recordable optical data storage media which are equally suitable both for CD-R and DVD-R systems (JP-A 11 043 481 and JP-A 10 181 206). In order to obtain high reflectivity, a high modulation level of the readout signal and sufficient sensitivity during recording, use is made of the fact that the IR wavelength 780 nm of the CD-R is located at the base of the long-wavelength slope of the absorption peak of the dye and the red wavelength 635 nm or 650 nm of the DVD-R is located at the base of the short-wavelength slope of the absorption peak of the dye. In JP-A 02 557 335, JP-A 10 058 828, JP-A 06 336 086, JP-A 02 865 955, WO-A 09 917 284 and U.S. Pat. No. 5,266,699 this concept is extended to cover the working wavelength range of 450 nm on the short-wavelength slope and the red and IR range on the long-wavelength slope of the absorption peak.

In addition to the abovementioned optical properties, the recordable information layer consisting of light-absorbing organic substances must have a morphology which is as amorphous as possible, in order to keep the noise signal during recording or reading as small as possible. For this purpose it is particularly preferable, when applying the substances by spin-coating from a solution or by vapour deposition and/or sublimation, to prevent crystallization of the light-absorbing substances during the subsequent top-coating with metallic or dielectric layers in vacuo.

The amorphous layer of light-absorbing substances should preferably have high thermal stability, since otherwise additional layers of organic or inorganic material applied by sputtering or vapour deposition onto the light-absorbing information layer form blurred boundaries due to diffusion and thus have an adverse effect on the reflectivity. In addition, if a light-absorbing substance has inadequate thermal stability at the boundary to a polymeric substrate, it can diffuse into the latter and again have an adverse effect on the reflectivity.

If the light-absorbing substance has too high a vapour pressure, it can sublime during the abovementioned sputtering or vapour deposition of additional layers in a high vacuum and thus reduce the desired layer thickness. This in turn has a negative effect on reflectivity.

The object of the invention is therefore to provide suitable compounds which meet the high demands (such as light stability, a favourable signal-to-noise ratio, damage-free application to the substrate material, etc.) for use in the information layer of a recordable optical data storage medium, in particular for high-density recordable optical data storage formats in a laser wavelength range of 340 to 680 nm.

Surprisingly, it has been found that light-absorbing compounds from the hemicyanine group of dyes are particularly suitable for satisfying the abovementioned requirement profile.

The invention therefore relates to an optical data storage medium containing a preferably transparent substrate which has optionally already been coated with one or more reflecting layers and onto the surface of which a photorecordable information layer, optionally one or more reflecting layers and optionally a protective layer or an additional substrate or a top layer are applied, which data storage medium can be recorded on and read using blue or red light, preferably laser light, wherein the information layer contains a light-absorbing compound and optionally a binder, characterized in that at least one hemicyanine dye is used as the light-absorbing compound.

Blue laser light is particularly preferred.

The light-absorbing compound should preferably be thermally modifiable. Preferably the thermal modification is carried out at a temperature of <600° C., particularly preferably at a temperature of <400° C., very particularly preferably at a temperature of <300° C., and in particular at a temperature of <200° C. Such a modification can for example be the decomposition or chemical modification of the chromophoric centre of the light-absorbing compound.

A hemicyanine of the formula I is preferred

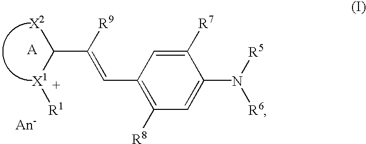

in which

X¹ represents nitrogen or

X¹—R¹ represents S,

X² represents O, S, N—R² or CR³R⁴,

R¹ and R² independently of one another represent C₁- to C₁₆-alkyl, C₃- to C₆-alkenyl, C₅- to C₇-cycloalkyl or C₇- to C₁₆-aralkyl,

R³ and R⁴ independently of one another represent C₁- to C₄-alkyl or

CR³R⁴ represents a bivalent radical of the formulae

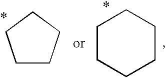

wherein the two bonds emanate from the ring atom marked with an asterisk (*),

A together with X¹, X² and the C-atom bound therebetween represents a five- or six-membered aromatic or quasi-aromatic heterocyclic ring which can contain 1 to 4 hetero atoms and/or can be benzo- or naphtho-fused and/or substituted by non-ionic radicals,

R⁵ and R⁶ independently of one another represent hydrogen, C₁- to C₁₆-alkyl, C₄- to C₇-cycloalkyl, C₇- to C₁₆-aralkyl, C₆- to C₁₀-aryl or a heterocyclic radical or

NR⁵R⁶ represents a five- or six-membered saturated ring which is attached via N and can additionally contain an N or O atom and/or be substituted by non-ionic radicals,

R⁷ represents hydrogen, C₁- to C₁₆-alkyl, C₁- to C₁₆-alkoxy or halogen or

R⁷ and R⁵ form a two- or three-membered bridge which can contain an O or N atom and/or be substituted by non-ionic radicals,

R⁸ represents hydrogen, C₁- to C₁₆-alkyl, C₁- to C₁₆-alkoxy, halogen, cyano, C₁- to C₄-alkoxycarbonyl, O—CO—R¹⁰, NR¹¹—CO—R¹¹, O—SO₂—R¹⁰ or NR¹¹—SO₂—R¹⁰,

R⁹ represents hydrogen, C₁- to C₄-alkyl, cyano, CO—O—R¹², CO—NR¹¹R¹², CS—O—R^{1 2} or CS—NR¹¹R¹²,

R¹⁰ represents hydrogen, C₁- to C₁₆-alkyl, C₄- to C₇-cycloalkyl, C₇- to C₁₆-aralkyl, C₁- to C₁₆-alkoxy, mono- or bis-C₁- to C₁₆-alkylamino, C₆- to C₁O-aryl, C₆- to C₁₀-aryloxy, C₆- to C₁₀-arylamino or a heterocyclic radical,

R¹¹ represents hydrogen or C₁- to C₄-alkyl,

R¹² represents C₁- to C₄-alkyl, C₄- to C₇-cycloalkyl, C₇- to C₁₆-aralkyl or C₆- to C₁₀-aryl and

An⁻ represents an anion.

X² may also represent CR³, wherein R³ has the abovementioned meaning.

Ring A, together with X¹, X² and the C-atom bound therebetween, may also be a partially hydrogenated heterocyclic ring.

Suitable non-ionic radicals are for example C₁- to C₄-alkyl, C₁- to C₄-alkoxy, halogen, cyano, nitro, C₁- to C₄-alkoxycarbonyl, C₁- to C₄-alkylthio, C₁- to C₄-alkanoylamino, benzoylamino, mono- or di-C₁- to C₄-alkylamino.

Alkyl, alkoxy, aryl and heterocyclic radicals can optionally contain additional radicals such as alkyl, halogen, nitro, cyano, CO—NH₂, alkoxy, trialkylsilyl, trialkylsiloxy or phenyl, the alkyl and alkoxy radicals can be straight-chain or branched, the alkyl radicals can be partially halogenated or perhalogenated, the alkyl and alkoxy radicals can be ethoxylated or propoxylated or silylated, adjacent alkyl and/or alkoxy radicals on aryl or heterocyclic radicals can together form a three- or four-membered bridge and the heterocyclic radicals can be benzo-fused and/or quaternized.

The ring A of the formula

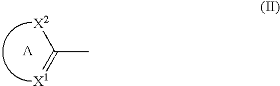

particularly preferably represents benzothiazol-2-yl, benzoxazol-2-yl, benzimidazol-2-yl, 3-H-indol-2-yl, 2- or 4-pyridyl or 2- or 4-quinolyl, wherein the aforementioned rings can each be substituted by C₁- to C₆-alkyl, C₁- to C₆-alkoxy, fluorine, chlorine, bromine, iodine, cyano, nitro, C₁- to C₆-alkoxycarbonyl, C₁- to C₆-alkylthio, C₁- to C₆-acylamino, C₆- to C₁₀-aryl, C₆- to C₁₀-aryloxy, C₆- to C₁₀-arylcarbonylamino, mono- or di-C₁- to C₆-alkylamino, N-C₁- to C₆-alkyl-N-C₆- to C₁₀-arylamino, pyrrolidino, morpholino or piperazino.

The ring A of the formula

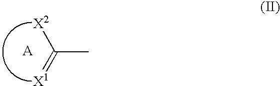

also particularly preferably represents thiazol-2-yl, thiazolin-2-yl, oxazol-2-yl, oxazolin-2-yl or pyrrolin-2-yl, wherein the aforementioned rings can each be substituted by C₁- to C₆-alkyl, C₁- to C₆-alkoxy, fluorine, chlorine, bromine, iodine, cyano, nitro, C₁- to C₆-alkoxycarbonyl, C₆- to C₁₀-aryl or C₆- to C₁₀-aryloxy.

In a particularly preferred form the hemicyanines used are those of the formula (I),

in which

the ring A of the formula

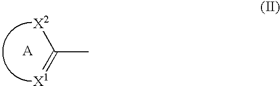

represents benzothiazol-2-yl, benzimidazol-2-yl, 3,3-dimethyl-3H-indol-2-yl, pyrimid-2-on-4-yl, 2- or 4-pyridyl or 2- or 4-quinolyl, wherein the aforementioned radicals can each be substituted by methyl, ethyl, methoxy, ethoxy, chlorine, cyano, methoxycarbonyl or ethoxycarbonyl,

R¹ represents methyl, ethyl, propyl, butyl, pentyl, hexyl, benzyl, phenethyl, phenylpropyl, allyl, cyclohexyl, chloroethyl, cyanomethyl, cyanoethyl, cyanopropyl, hydroxyethyl, 2-hydroxypropyl, methoxyethyl, ethoxyethyl or a radical of the formula

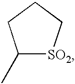

R² , if the ring A represents benzimidazol-2-yl, has the same meaning as R¹,

R⁵ and R⁶ independently of one another represent methyl, ethyl, propyl, butyl, pentyl, hexyl, benzyl, phenethyl, phenylpropyl, cyclohexyl, chloroethyl, cyanomethyl, cyanoethyl, cyanopropyl, hydroxyethyl, 2-hydroxypropyl, methoxyethyl, ethoxyethyl, methoxycarbonylethyl, ethoxycarbonylethyl, acetoxyethyl, propionyloxyethyl, phenyl, tolyl, methoxyphenyl, chlorophenyl, cyanophenyl or a radical of the formula

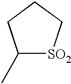

and R⁵ can additionally represent hydrogen or

NR⁵R 6represents pyrrolidino, piperidino, N-methylpiperidino, N-ethylpiperidino, N-hydroxyethylpiperidino or morpholino,

R⁷ represents hydrogen, methyl, methoxy or chlorine or

R⁷;R⁵ represent a —(CH₂)₂—, —(CH₂)₃—, —C(CH₃)—CH₂—C(CH₃)₂— or —O—(CH₂)₂— bridge,

R⁸ represents hydrogen, methyl, methoxy or chlorine,

R⁹ represents hydrogen and

An⁻ represents an anion.

Suitable anions An⁻ are all monovalent anions or one equivalent of a polyvalent anion. Preferably the anions are colourless. Suitable anions are, for example, chloride, bromide, iodide, tetrafluoroborate, perchlorate, hexafluorosilicate, hexafluorophosphate, methosulphate, ethosulphat, C₁- to C₁₀-alkanesulphonate, C₁- to C₁₀-perfluoroalkane sulphonate, C₁- to C₁₀-alkanoate optionally substituted by chlorine, hydroxyl or C₁- to C₄ alkoxy, benzene sulphonate, naphthalene sulphonate or biphenyl sulphonate optionally substituted by nitro, cyano, hydroxyl, C₁- to C₂₅-alkyl, perfluoro-C₁- to C₄-alkyl, C₁- to C₄-alkoxycarbonyl or chlorine, benzene disulphonate, naphthalene disulphonate or biphenyl disulphonate optionally substituted by nitro, cyano, hydroxyl, C₁- to C₄-alkyl, C₁- to C₄-alkoxy, C₁- to C₄-alkoxycarbonyl or chlorine, benzoate optionally substituted by nitro, cyano, C₁- to C₄-alkyl, C₁- to C₄-alkoxy, C₁- to C₄-alkoxycarbonyl, benzoyl, chlorobenzoyl or toluoyl, the anion of naphthalenedicarboxylic acid, diphenyl ether disulphonate, tetraphenyl borate, cyanotriphenyl borate, tetra-C₁- to C₂₀-alkoxyborate, tetraphenoxyborate, 7,8- or 7,9-dicarba-nido-undecaborate(1-) or (2-), which are optionally substituted on the B- and/or C-atoms by one or two C₁- to C₁₂-alkyl or phenyl groups, dodecahydro-dicarbadodecaborate(2-) or B-C₁- to C₁₂-alkyl-C-phenyl-dodecahydro-dicarbadodecaborate(1-).

Bromide, iodide, tetrafluoroborate, perchlorate, methane sulphonate, benzene sulphonate, toluene sulphonate, dodecylbenzene sulphonate and tetradecane sulphonate are preferred.

In a very particularly preferred form the hemicyanines used are those of the formulae (III) to (VI)

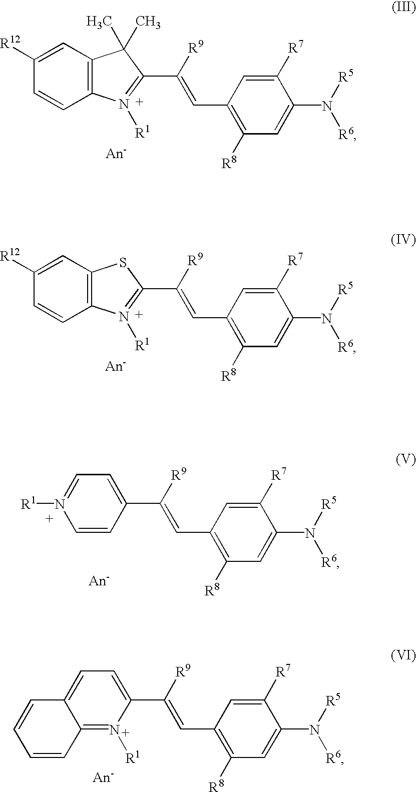

in which

R¹ represents methyl, ethyl, propyl, butyl, pentyl, hexyl, benzyl, cyclohexyl, chloroethyl, cyanomethyl, cyanoethyl, hydroxyethyl, 2-hydroxypropyl, methoxyethyl, ethoxyethyl or a radical of the formula

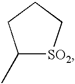

R⁵ and R⁶ independently of one another represent methyl, ethyl, propyl, butyl, pentyl, hexyl, benzyl, cyclohexyl, chloroethyl, cyanoethyl, hydroxyethyl, 2-hydroxypropyl, methoxyethyl, ethoxyethyl, methoxycarbonylethyl, ethoxycarbonylethyl, acetoxyethyl, phenyl, tolyl or methoxyphenyl or

NR⁵R⁶ represents pyrrolidino, N-methylpiperidino or morpholino,

R⁷ represents hydrogen or

R⁷;R⁵ represent a —(CH₂)₂—, —C(CH₃)—CH₂—C(CH₃)₂- or —O—(CH₂)₂- bridge,

R⁸ represents hydrogen,

R⁹ represents hydrogen and

An⁻ represents tetrafluoroborate, perchlorate, hexafluorosilicate, iodide, rhodanide, cyanate, hydroxy acetate, methoxy acetate, lactate, citrate, methane sulphonate, ethane sulphonate, benzene sulphonate, toluene sulphonate, butylbenzene sulphonate, chlorobenzene sulphonate, dodecylbenzene sulphonate or naphthalene sulphonate.

An⁻ can also represent hexafluorophosphate.

In a form which is also very particularly preferred the hemicyanines used are those of the formulae (IIIa) and (IVa)

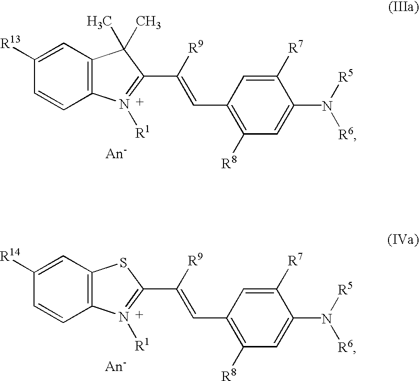

in which

R¹ represents methyl, ethyl, propyl, butyl, pentyl, hexyl, benzyl, cyclohexyl, chloroethyl, cyanomethyl, cyanoethyl, hydroxyethyl, 2-hydroxypropyl, methoxyethyl, ethoxyethyl or a radical of the formula

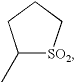

R⁵ and R⁶ independently of one another represent methyl, ethyl, propyl, butyl, pentyl, hexyl, benzyl, cyclohexyl, chloroethyl, hydroxyethyl, 2-hydroxypropyl, methoxyethyl, ethoxyethyl, methoxycarbonylethyl, ethoxycarbonylethyl, acetoxyethyl, phenyl, tolyl or methoxyphenyl or

NR⁵R⁶ represents pyrrolidino, N-methylpiperidino, morpholino or N,N-bis-(2-cyanoethyl)amino,

R⁷ represents hydrogen or

R⁷;R⁵ represents a —(CH₂)₂—, —C(CH₃)—CH₂—C(CH₃)₂— or —O—(CH₂)₂- bridge,

R⁸ represents hydrogen,

R⁹ represents hydrogen,

R¹³ represents hydrogen, methyl, methoxy, chlorine, nitro, cyano or methoxycarbonyl,

R¹⁴ represents hydrogen, methyl, methoxy or ethoxy and

An⁻ represents tetrafluoroborate, perchlorate, hexafluorosilicate, hexafluorophosphate, iodide, rhodanide, cyanate, hydroxy acetate, methoxy acetate, lactate, citrate, methane sulphonate, ethane sulphonate, benzene sulphonate, toluene sulphonate, butylbenzene sulphonate, chlorobenzene sulphonate, dodecylbenzene sulphonate or naphthalene sulphonate.

Preferably R¹³ represents hydrogen, methyl, methoxy or methoxycarbonyl and R¹⁴ represents hydrogen.

In a form which is also very particularly preferred the hemicyanines used are those of the formulae (VII) to (IX)

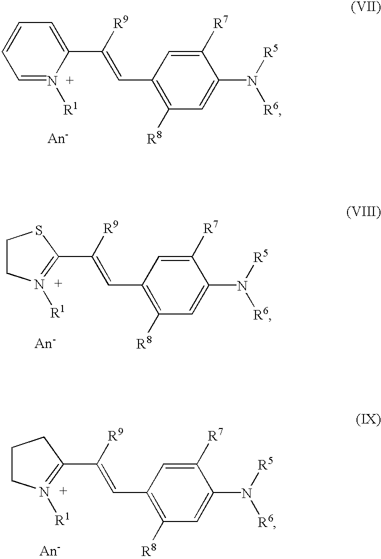

in which

R¹ represents methyl, ethyl, propyl, butyl, pentyl, hexyl, benzyl, cyclohexyl, chloroethyl, cyanomethyl, cyanoethyl, hydroxyethyl, 2-hydroxypropyl, methoxyethyl, ethoxyethyl or a radical of the formula

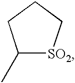

R⁵ and R⁶ independently of one another represent methyl, ethyl, propyl, butyl, pentyl, hexyl, benzyl, cyclohexyl, chloroethyl, cyanoethyl, hydroxyethyl, 2-hydroxypropyl, methoxyethyl, ethoxyethyl, methoxycarbonylethyl, ethoxycarbonylethyl, acetoxyethyl, phenyl, tolyl or methoxyphenyl or

NR⁵R⁶ represents pyrrolidino, N-methylpiperidino or morpholino,

R⁷ represents hydrogen or

R⁷;R⁵ represent a —(CH₂)₂—, —C(CH₃)—CH₂—C(CH₃)₂— or —O—(CH₂)₂-bridge,

R⁸ represents hydrogen,

R⁹ represents hydrogen,

An⁻ represents tetrafluoroborate, perchlorate, hexafluorosilicate, hexafluorophosphate, iodide, rhodanide, cyanate, hydroxy acetate, methoxy acetate, lactate, citrate, methane sulphonate, ethane sulphonate, benzene sulphonate, toluene sulphonate, butylbenzene sulphonate, chlorobenzene sulphonate, dodecylbenzene sulphonate or naphthalene sulphonate.

For a recordable optical data storage medium according to the invention which is recorded on and read using light from a blue laser, such hemicyanine dyes are preferred whose absorption maximum λₘₐₓ₂ is in the range from 420 to 550 nm, wherein the wavelength λ_{½} at which the extinction on the short-wavelength slope of the absorption maximum of the wavelength λₘₐₓ₂ is half the extinction value at λₘₐₓ₂, and the wavelength λ_{1/10}, at which the extinction on the short-wavelength slope of the absorption maximum of the wavelength λₘₐₓ₂ is a tenth of the extinction value at λₘₐₓ₂ are preferably in each case no further than 50 nm away from each other. Preferably such a hemicyanine dye does not display a shorter-wave maximum λₘₐₓ₁ at a wavelength below 350 nm, particularly preferably below 320 nm, and very particularly preferably below 290 nm.

Preferred hemicyanine dyes are those with an absorption maximum λₘₐₓ₂ of 410 to 530 nm.

Particularly preferred hemicyanine dyes are those with an absorption maximum λₘₐₓ₂ of 420 to 510 nm.

Very particularly preferred hemicyanine dyes are those with an absorption maximum λₘₐₓ₂ of 430 to 500 mn.

In these hemicyanine dyes λ_{½} and λ_{1/10}, as defined above, are preferably no further than 40 nm, particularly preferably no further than 30 nm, and very particularly preferably no further than 20 nm away from each other.

For a recordable optical data storage medium according to the invention which is recorded on and read using light from a red laser, such hemicyanine dyes are preferred whose absorption maximum λₘₐₓ₂ is in the range from 500 to 650 mn, wherein the wavelength λ_{½} at which the extinction on the long-wavelength slope of the absorption maximum of the wavelength λₘₐₓ₂ is half the extinction value at λₘₐₓ₂, and the wavelength λ_{1/10}, at which the extinction on the long-wavelength slope of the absorption maximum of the wavelength λₘₐₓ₂ is a tenth of the extinction value at λₘₐₓ₂, are preferably in each case no further than 50 nm away from each other. Preferably such a hemicyanine dye does not display a longer-wave maximum λₘₐₓ₃ at a wavelength below 750 nm, particularly preferably below 800 nm, and very particularly preferably below 850 nm.

Preferred hemicyanine dyes are those with an absorption maximum λₘₐₓ₂ of 530 to 630 nm.

Particularly preferred hemicyanine dyes are those with an absorption maximum λₘₐₓ₂ of 550 to 620 nm.

Very particularly preferred hemicyanine dyes are those with an absorption maximum λₘₐₓ₂ of 580 to 610 nm.

In these hemicyanine dyes λ_{½} and λ_{1/10}, as defined above, are preferably no further than 40 nm, particularly preferably no further than 30 nm, and very particularly preferably no further than 20 nm away from each other.

At the absorption maximum λₘₐₓ₂ the hemicyanine dyes have a molar extinction coefficient ε of >40000 l/mol cm, preferably >60000 l/mol cm, particularly preferably >80000l/mol cm and very particularly preferably >100000l/mol cm.

The absorption spectra are, for example, measured in solution.

Suitable hemicyanines having the required spectral properties are in particular those in which the change in the dipole moment Δμ=|μ_{g}−μ_{ag}|, i.e. the positive difference between the dipole moments in the ground state and the first excited state is as small as possible, i.e. preferably <5 D, and particularly preferably <2 D. A method of determining such a change in the dipole moment As is described, for example, in F. Würthner et al., Angew. Chem. 1997, 109, 2933 and in the literature cited therein. Low solvatochromism (methanol/methylene chloride) is also a suitable criterion for selection. Preferred hemicyanines are those whose solvatochromism Δλ=|λ_{methylene chloride}−λₘₑₜₕₐₙₒₗ|, i.e. the positive difference between the absorption wavelengths in the solvents methylene chloride and methanol, is <25 nm, particularly preferably <15 nm, and very particularly preferably <5 nm.

Hemicyanines which are very particularly preferred according to the invention are those of the formulae (III) and (V).

Hemicyanines of the formulae (I) and (III) to (VI) are known, for example, from DE-OS 2 932 092, DE-P 891 120, DE-P 721 020 and DE-OS 1 569 606.

The light-absorbing substances described guarantee sufficiently high reflectivity (>10%) of the optical data storage medium in the unrecorded state and sufficiently high absorption for the thermal degradation of the information layer upon spotwise illumination with focussed light, if the wavelength of the light is in the range from 360 to 460 nm and 600 to 680 nm. The contrast between the recorded and unrecorded areas of the data storage medium is effected by the change in reflectivity in terms of the amplitude as well as the phase of the incident light as a result of the changed optical properties of the information layer following thermal degradation.

The hemicyanine dyes are preferably applied to the optical data storage medium by spin-coating or vacuum coating. The hemicyanines can be mixed with other hemicyanines or with other dyes having similar spectral properties. The information layer can contain additives in addition to the hemicyanine dyes, such as binders, wetting agents, stabilizers, diluents and sensitizers as well as other constituents.

In addition to the information layer, the optical data storage medium can contain other layers such as metal layers, dielectric layers and protective layers. Metals and dielectric layers are used, for example, for adjusting the reflectivity and the thermal balance. Depending on the laser wavelength, the metals can be gold, silver or aluminium, etc. Dielectric layers are, for example, silicon dioxide and silicon nitride. Protective layers are, for example, photocurable surface coatings, adhesive layers and protective films.

Adhesive layers can consist of a pressure-sensitive material.

The invention also relates to a once recordable optical data storage medium containing a preferably transparent substrate, onto the surface of which at least one photorecordable information layer, optionally a reflecting layer and/or optionally a protective layer are applied, which data storage medium can be recorded on and read using blue light, preferably laser light, wherein the information layer contains at least one of the abovementioned light-absorbing compounds and optionally a binder, wetting agents, stabilizers, diluents and sensitizers as well as other constituents. Alternatively, the assembly of the optical data storage medium can contain:

a preferably transparent substrate, onto whose surface at least one photorecordable information layer, optionally a reflecting layer and optionally an adhesive layer and an additional, preferably transparent substrate, are applied.

a preferably transparent substrate, onto whose surface optionally a reflecting layer, at least one photorecordable information layer, optionally an adhesive layer and a transparent top layer are applied.

Pressure-sensitive adhesive layers consist mainly of acrylic adhesives. Nitto Denko DA-8320 or DA-8310, which are disclosed in the patent JP-A 11-273147, can, for example, be used for this purpose.

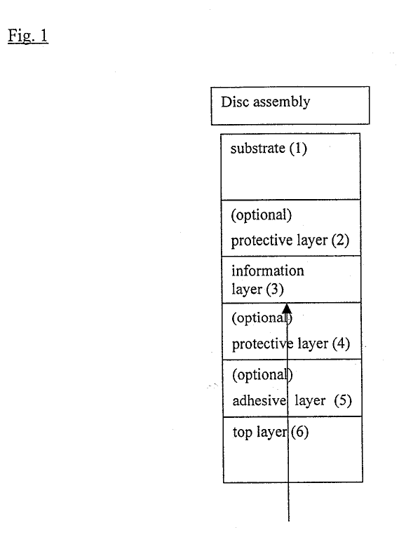

The optical data storage medium has, for example, the following layer assembly (cf. FIG. 1): a transparent substrate (1), optionally a protective layer (2), an information layer (3), optionally a protective layer (4), optionally an adhesive layer (5) and a top layer (6).

Preferably, the optical data storage medium assembly can contain:

a preferably transparent substrate (1), onto whose surface at least one photorecordable information layer (3), which can be recorded on using light, preferably laser light, optionally a protective layer (4), optionally an adhesive layer (5) and a transparent top layer (6) are applied;

a preferably transparent substrate (1), onto whose surface a protective layer (2), at least one information layer (3) which can be recorded on using light, preferably laser light, optionally an adhesive layer (5) and a transparent top layer (6) are applied;

a preferably transparent substrate (1), onto whose surface optionally a protective layer (2), at least one information layer (3) which can be recorded on using light, preferably laser light, optionally a protective layer (4), optionally an adhesive layer (5) and a transparent top layer (6) are applied;

a preferably transparent substrate (1), onto whose surface at least one information layer (3) which can be recorded on using light, preferably laser light, optionally an adhesive layer (5) and a transparent top layer (6) are applied.

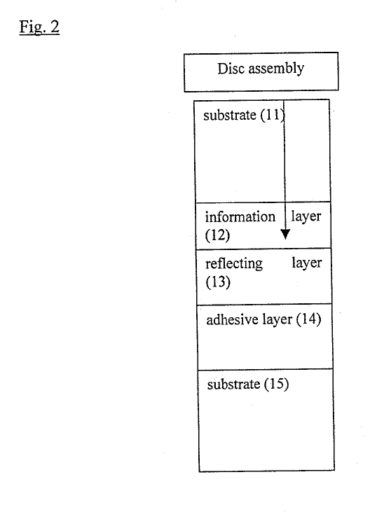

Alternatively, the optical data storage medium has for example the following layer assembly (cf. FIG. 2): a preferably transparent substrate (11), an information layer (12), optionally a reflecting layer (13), optionally an adhesive layer (14) and an additional, preferably transparent, substrate (15).

The invention also relates to optical data storage media according to the invention which are recorded on using blue or red light, in particular laser light.

The following examples illustrate the subject matter of the invention:

### EXAMPLES

### Example 1

1,4 g of 5-dimethylaminofuran-2-carbaldehyde and 1.74 g of 1,3,3-trimethyl-2-methylene-3H-indole were stirred in a mixture of 5 ml of glacial acetic acid and 1 ml of acetic anhydride for 2 h at 40° C. After cooling, the mixture was discharged onto 80 ml of water, in which 2.6 g of sodium tetrafluoroborate were dissolved. The mixture was filtered off by suction and the residue was washed with water and dried. 1.6 g (42% of theory) of a red powder of the formula

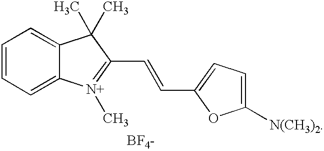

was obtained.

M.p. =218° C.

λₘₐₓ (methanol) 551 nm

ε=87670 l/mol cm

λ_{½} (short-wave slope) 41 nm

λ_{½} (long-wave slope) =30 nm

Solubility: >2% in TFP (2,2,3,3-tetrafluoropropanol)

a glassy film

Hemicyanine dyes which are also suitable are listed in the table:

| Ex. | 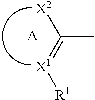 | R⁹ | 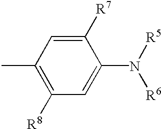 |
|---|---|---|---|
| 2 | 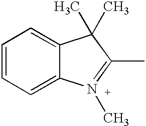 | H | 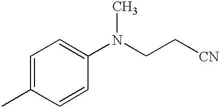 |
| 3 | 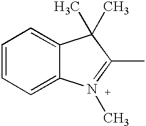 | H | 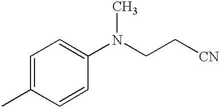 |
| 4 | 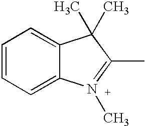 | H | 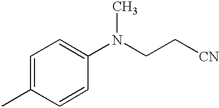 |
| 5 | 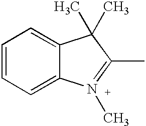 | H | 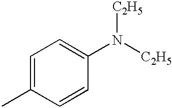 |
| 6 | 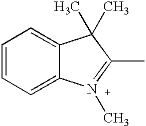 | H | 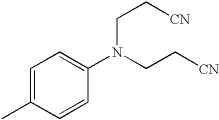 |
| 7 | 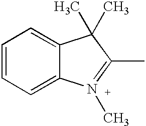 | H | 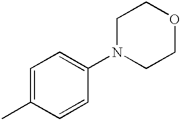 |
| 8 | 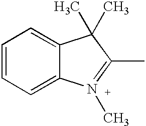 | H | 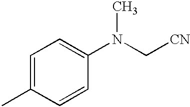 |
| 9 | 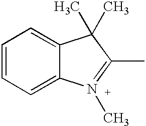 | H | 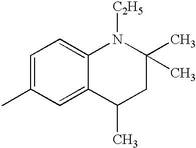 |
| 10 | 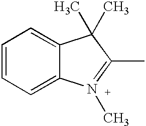 | H | 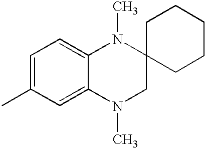 |
| 11 | 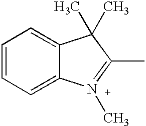 | H | 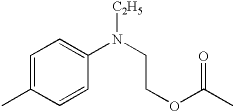 |
| 12 | 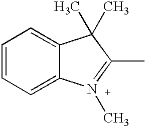 | H | 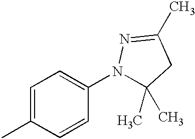 |
| 13 | 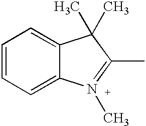 | H | 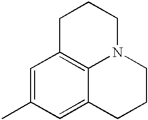 |
| 14 | 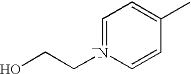 | H | 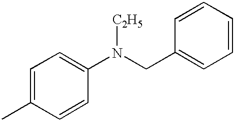 |
| 15 | 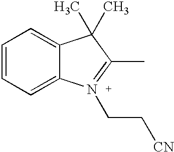 | H | 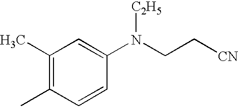 |
| 16 | 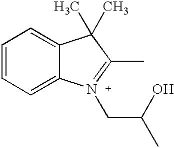 | H | 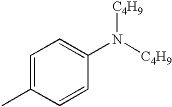 |
| 17 | 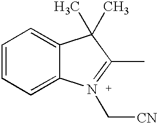 | H | 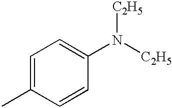 |
| 18 | 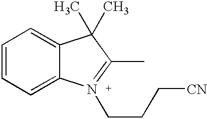 | H | 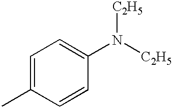 |
| 19 | 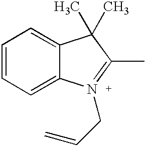 | H | 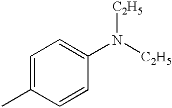 |
| 20 | 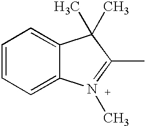 | 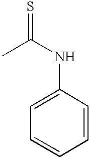 | 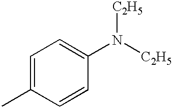 |
| 21 | 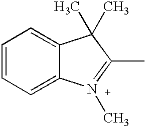 | CN | 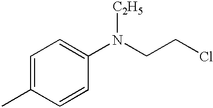 |
| 22 | 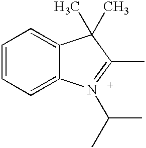 | H | 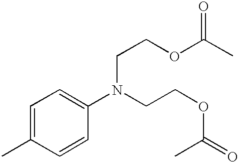 |
| 23 | 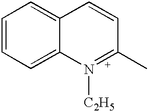 | H | 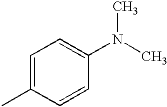 |
| 24 | 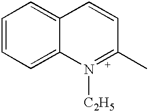 | H | 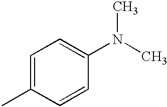 |
| 25 | 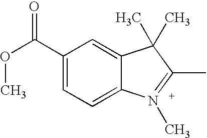 | H | 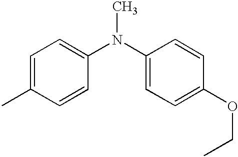 |
| 26 | 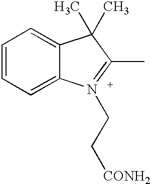 | H | 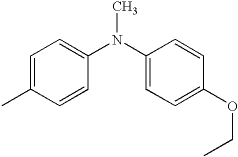 |
| 27 | 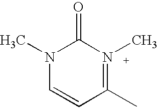 | H | 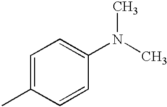 |
| 28 | 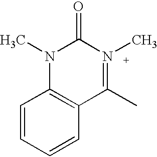 | H | 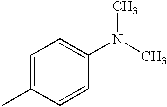 |
| 29 | 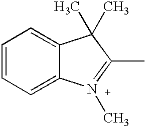 | H | 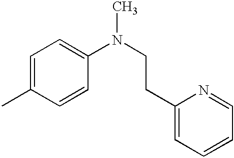 |
| 30 | 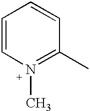 | H | 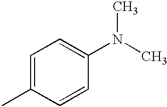 |
| 31 | 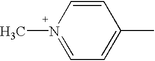 | H | 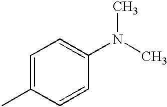 |
| 32 | 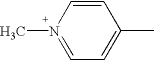 | H | 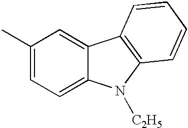 |
| 33 | 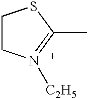 | H | 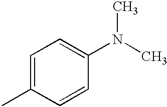 |

| Ex. | An⁻ | λₘₐₓ/nm¹⁾ | ε/l/mol/cm | λ_{1/2}-λ_{1/10}/nm | Δλ²⁾/nm |
|---|---|---|---|---|---|
| 2 | BF₄⁻ | 524 | 68370 | 41³⁾ | 16 |
| 3 | ClO₄− | 524 | 68370 | | |
| 4 | 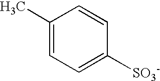 | 524 | 68370 | | |
| 5 | Cl⁻ | 551 | | 14⁴⁾ | 18 |
| 6 | BF₄− | 500 | 63500 | | |
| 7 | ZnCl₃⁻ | 517 | 56300 | | |
| 8 | BF₄− | 512 | | | |
| 9 | ClO₄⁻ | 562 | 97300 | | |
| 10 | ClO₄⁻ | 524 | 52400 | | |
| 11 | ClO₄⁻ | 540 | 86300 | | |
| 12 | ClO₄⁻ | | | | |
| 13 | C₄H₉SO₃⁻ | 576 | 70700 | | |
| 14 | BF₄⁻ | 482 | 47000 | 38⁴⁾ | 16 |
| 15 | ClO₄⁻ | 558 | 100500 | | |
| 16 | Cl⁻ | 560⁵⁾ | 74000 | | |
| 17 | ClO₄⁻ | 557 | 90000 | | |
| 18 | BF₄⁻ | 557 | 70000 | | |
| 19 | ClO₄⁻ | 556 | 75000 | | |
| 20 | ClO₄⁻ | 548 | 109000 | | |
| 21 | CH₃SO₃⁻ | | | | |
| 22 | CF₃COO⁻ | | | | |
| 23 | I⁻ | 525 | 57570 | 47³⁾ | 23 |
| 24 | BF₄⁻ | 525 | 57570 | | |
| 25 | BF₄⁻ | | | | |
| 26 | ClO₄⁻ | 546 | 83000 | | |
| 27 | ½PF₆²⁻ | | | | |
| 28 | BF₄⁻ | 572 | | | |
| 29 | ClO₄⁻ | 542 | | | |
| 30 | I⁻ | 462 | | | |
| 31 | I⁻ | 475 | | | |
| 32 | I⁻ | 436 | | | |
| 33 | ClO₄⁻ | 478 | 58215 | 21⁴⁾ | 23 |

¹⁾in methanol, unless indicated otherwise.
²⁾Δλ = |λ_{methylene chloride} − λₘₑₜₕₐₙₒₗ|
³⁾on the short-wave slope
⁴⁾on the long-wave slope
⁵⁾in water

### Example 34

A 4% by weight solution of the dye of Example 2 in 2,2,3,3-tetrafluoropropanol was prepared at room temperature. This solution was applied by means of spin-coating to a pre-grooved polycarbonate substrate. The pre-grooved polycarbonate substrate was produced in the form of a disc by injection-moulding. The dimensions of the disc and the groove structure corresponded to those usually employed for DVD-R's. The disc containing the dye layer as the information carrier was vapour-plated with 100 nm of silver. Then a UV-curable acrylic lacquer was applied by spin-coating and cured using a UV lamp. Using a dynamic recording test setup constructed on an optical bench and consisting of a diode laser (λ=405 nm) for producing linearly polarized light, a polarization-sensitive beam splitter, a λ/4-plate and a movably suspended collective lens with a numerical aperture NA of 0.65 (actuator lens), experiments on the recording (writing) and reading of data were carried out. The light reflected from the reflecting layer of the disc was coupled out of the beam path with the aid of the abovementioned polarization-sensitive beam splitter and focussed onto a four-quadrant detector through an astigmatic lens. At a linear velocity of V=2.6 m/s and a recording (writing) power of P_{w}=13.2 mW a signal-to-noise ratio of C/N=47 dB was measured. The recording power was applied as an oscillating pulse sequence, the disc being irradiated alternately for 1 μs with the abovementioned recording power P_{w} and for 4 μs with the reading power Pᵣ≈0.44 mW. The disc was irradiated with this oscillating pulse sequence until it had turned completely a single time. Then the marking produced was read with a reading power Pᵣ≈0.44 mW and the abovementioned signal-to-noise ratio C/N was determined.

Optical data storage media were obtained analogously using the other examples from the above table.

1. An optical data storage medium containing a preferably transparent substrate which has optionally already been coated with one or more reflecting layers and onto the surface of which a photorecordable information layer, optionally one or more reflecting layers and optionally a protective layer or an additional substrate or a top layer are applied, which data storage medium can be recorded on and read using blue or red light, preferably laser light, wherein the information layer contains a light-absorbing compound and optionally a binder, characterized in that at least one hemicyanine dye is used as the light-absorbing compound.

2. An optical data storage medium according to claim 1, characterized in that the hemicyanine corresponds to the formula I 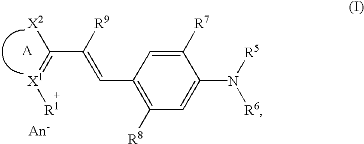
in which
X¹ represents nitrogen or
X¹—R¹ represents S,
X² represents O, S, N—R² or CR³R⁴,
R¹ and R² independently of one another represent C₁- to C₁₆-alkyl, C₃- to C₆-alkenyl, C₅- to C₇-cycloalkyl or C₇- to C₁₆-aralkyl,
R³ and R⁴ independently of one another represent C₁- to C₄-alkyl or CR³R⁴ represents a bivalent radical of the formulae 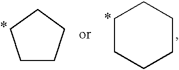
wherein the two bonds emanate from the ring atom marked with an asterisk (*),
A together with X¹, X² and the C-atom bound therebetween, represents a five- or six-membered aromatic or quasi-aromatic heterocyclic ring which can contain 1 to 4 hetero atoms and/or can be benzo- or naphtho-fused and/or substituted by non-ionic radicals,
R⁵ and R⁶ independently of one another represent hydrogen, C₁- to C₁₆-alkyl, C₄- to C₇-cycloalkyl, C₇- to C₁₆-aralkyl, C₆- to C₁₀-aryl or a heterocyclic radical or
NR⁵R⁶ represents a five- or six-membered saturated ring which is attached via N and can additionally contain an N or O atom and/or can be substituted by non-ionic radicals,
R⁷ represents hydrogen, C₁- to C₁₆-alkyl, C₁- to C₁₆-alkoxy or halogen or
R⁷ and R⁵ form a two- or three-membered bridge which can contain an O or N atom and/or can be substituted by non-ionic radicals,
R⁸ represents hydrogen, C₁- to C₁₆-alkyl, C₁- to C₁₆-alkoxy, halogen, cyano, C₁- to C₄-alkoxycarbonyl, O—CO—R¹⁰, NR¹¹—CO—R¹⁰, O—SO₂—R¹⁰ or NR¹¹—SO₂—R¹⁰,
R⁹ represents hydrogen, C₁- to C₄-alkyl, cyano, CO—O—R¹², CO—NR¹¹R¹², CS—O—R¹² or CS—NR¹¹R¹²,
R¹⁰ represents hydrogen, C₁- to C₁₆-alkyl, C₄- to C₇-cycloalkyl, C₇- to C₁₆-aralkyl, C₁- to C₁₆-alkoxy, mono- or bis-C₁- to C₁₆-alkylamino, C₆- to C₁₀-aryl, C₆- to C₁₀-aryloxy, C₆- to C₁₀-arylamino or a heterocyclic radical,
R¹¹ represents hydrogen or C₁- to C₄-alkyl,
R¹² represents C₁- to C₄-alkyl, C₄- to C₇-cycloalkyl, C₇- to C₁₆-aralkyl or C₆- to C₁₀-aryl and
An⁻ represents an anion.

3. An optical data storage medium according to claim 2, characterized in that in
the formula (I)
the ring A of the formula 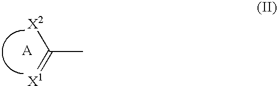
represents benzothiazol-2-yl, benzoxazol-2-yl, benzimidazol-2-yl, 3-H-indol-2-yl, pyrimid-2-on-4-yl or 2- or 4-quinolyl, wherein the aforementioned rings can each be substituted by C₁- to C₆-alkyl, C₁- to C₆-alkoxy, fluorine. chlorine, bromine, iodine, cyano, nitro, C₁- to C₆-alkoxycarbonyl, C₁- to C₆-alkylthio, C₁- to C₆-acylamino, C₆- to C₁₀-aryl, C₆- to C₁₀-aryloxy, C₆- to C₁₀-arylcarbonylamino, mono- or di-C₁- to C₆-alkylamino, N—C₁- to C₆-alkyl-N-C₆- to C₁₀-arylamino, pyrrolidino, morpholino or piperazino.

4. An optical data storage medium according to one or more of claims 2 to 3, characterized in that the hemicyanine corresponds to the formula (I),
in which
the ring A of the formula 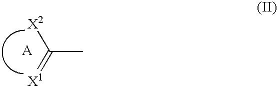
represents benzothiazol-2-yl, benzimidazol-2-yl, 3,3-dimethyl-3H-,indol-2-yl, pyrimid-2-on-4-yl, 2- or 4-pyridyl or 2- or 4-quinolyl, wherein the aforementioned rings can each be substituted by methyl, ethyl, methoxy, ethoxy, chlorine, cyano, methoxycarbonyl or ethoxycarbonyl,
R¹ represents methyl, ethyl, propyl, butyl, pentyl, hexyl, benzyl, phenethyl, phenylpropyl, allyl, cyclohexyl, chloroethyl, cyanomethyl, cyanoethyl, cyanopropyl, hydroxyethyl, 2-hydroxypropyl, methoxyethyl, ethoxyethyl or a radical of the formula 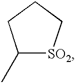
R², if the ring A represents benzimidazol-2-yl, has the same meaning as
R⁵ and R⁶ independently of one another represent methyl, ethyl, propyl, butyl, pentyl, hexyl, benzyl, phenethyl, phenylpropyl, cyclohexyl, chloroethyl, cyanomethyl, cyanoethyl, cyanopropyl, hydroxyethyl, 2-hydroxypropyl, methoxyethyl, ethoxyethyl, methoxycarbonylethyl, ethoxycarbonylethyl, acetoxyethyl, propionyloxyethyl, phenyl, tolyl, methoxyphenyl, chlorophenyl, cyanophenyl or a radical of the formula 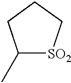
and R⁵ can additionally represent hydrogen or
NR⁵R⁶ represents pyrrolidino, piperidino, N-methylpiperidino, N-ethylpiperidino, N-hydroxyethylpiperidino or morpholino,
R⁷ represents hydrogen, methyl, methoxy or chlorine or
R⁷;R⁵ represent a —(CH₂)₂—, —(CH₂)₃-, —C(CH₃)—CH₂—C(CH₃)₂— or —O—(CH₂)₂-bridge,
R⁸ represents hydrogen, methyl, methoxy or chlorine,
R⁹ represents hydrogen and
An⁻ represents an anion.

5. An optical data storage medium according to claim 2, characterized in that in the formula (I)
the ring A of the formula 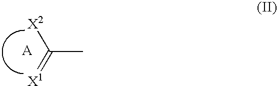
represents thiazol-2-yl, thiazolin-2-yl, oxazol-2-yl, oxazolin-2-yl or pyrrolin-2-yl, wherein the aforementioned rings can each be substituted by C₁- to C₆-alkyl, C₁- to C₆-alkoxy, fluorine, chlorine, bromine, iodine, cyano, nitro, C₁- to C₆-alkoxycarbonyl, C₆- to C₁₀-aryl or C₆- to C₁₀-aryloxy.

6. An optical data storage medium according to one or more of claims 1 to 4, characterized in that the hemicyanine corresponds to the formula (III) 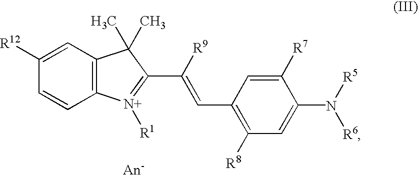
in which
R¹ represents methyl, ethyl, propyl, butyl, pentyl, hexyl, benzyl, cyclohexyl, chloroethyl, cyanomethyl, cyanoethyl, hydroxyethyl, 2-hydroxypropyl, methoxyethyl, ethoxyethyl or a radical of the formula 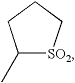
R⁵ and R⁶ independently of one another represent methyl, ethyl, propyl, butyl, pentyl, hexyl, benzyl, cyclohexyl, chloroethyl, cyanoethyl, hydroxyethyl, 2-hydroxypropyl, methoxyethyl, ethoxyethyl, methoxycarbonylethyl, ethoxycarbonylethyl, acetoxyethyl, phenyl, tolyl or methoxyphenyl or
NR⁵R⁶ represents pyrrolidino, N-methylpiperidino or morpholino,
R⁷ represents hydrogen or
R⁷;R⁵ represent a —(CH₂)₂—, —C(CH₃)—CH₂—C(CH₃)₂— or —O—(CH₂)₂- bridge,
R⁸ represents hydrogen,
R⁹ represents hydrogen and
An⁻ represents tetrafluoroborate, perchlorate, hexafluorosilicate, iodide, rhodanid, cyanate, hydroxy acetate, methoxy acetate, lactate, citrate, methane sulphonate, ethane sulphonate, benzene sulphonate, toluene sulphonate, butylbenzene sulphonate, chlorobenzene sulphonate, dodecylbenzene sulphonate or naphthalene sulphfonate.

7. An optical data storage medium according to one or more of claims 1 to 4, characterized in that the hemicyanine corresponds to the formula (IV) 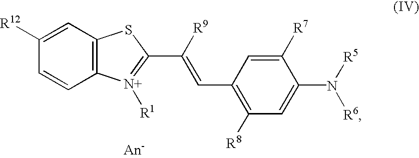
in which
R¹, R⁵ to R⁹ and An⁻ have the meaning given in claim 5.

8. An optical data storage medium according to one or more of claims 1 to 4, characterized in that the hemicyanine corresponds to the formula (V) 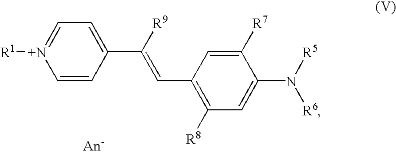
in which
R¹, R⁵ to R⁹ and An⁻ have the meaning given in claim 5.

9. An optical data storage medium according to one or more of claims 1 to 4, characterized in that the hemicyanine corresponds to the formula (VI) 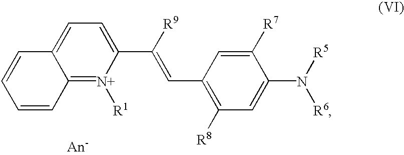
in which
R¹, R⁵ to R⁹ and An⁻ have the meaning given in claim 5.

10. An optical data storage medium according to one or more of claims 1 to 4, characterized in that the hemicyanine corresponds to the formula (IIIa) 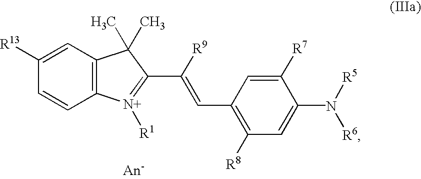
in which
R¹ represents methyl, ethyl, propyl, butyl, pentyl, hexyl, benzyl, cyclohexyl, chloroethyl, cyanomethyl, cyanoethyl, hydroxyethyl, 2-hydroxypropyl, methoxyethyl, ethoxyethyl or a radical of the formula 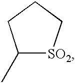
R⁵ and R⁶ independently of one another represent methyl, ethyl, propyl, butyl, pentyl, hexyl, benzyl, cyclohexyl, chloroethyl, hydroxyethyl, 2-hydroxypropyl, methoxyethyl, ethoxyethyl, methoxycarbonylethyl, ethoxycarbonylethyl, acetoxyethyl, phenyl, tolyl or methoxyphenyl or
NR⁵R⁶ represents pyrrolidino, N-methylpiperidino, morpholino or N,N-bis-(2-cyanoethyl)amino,
R⁷ represents hydrogen or
R⁷;R⁵ represent a —(CH₂)₂—, —C(CH₃)—CH₂—C(CH₃)₂— or —O—(CH₂)₂-bridge,
R⁸ represents hydrogen,
R⁹ represents hydrogen,
R¹³ represents hydrogen, methyl, methoxy, chlorine, nitro, cyano or methoxycarbonyl and
An⁻ represents tetrafluoroborate, perchlorate, hexafluorosilicate, hexafluorophosphate, iodide, rhodanide, cyanate, hydroxy acetate, methoxy acetate, lactate, citrate, methane sulphonate, ethane sulphonate, benzene sulphonate, toluene sulphonate, butylbenzene sulphonat, chlorobenzene sulphonate, dodecylbenzene sulphonate or naphthalene sulphonate.

11. An optical data storage medium according to one or more of claims 1 to 4, characterized in that the hemicyanine corresponds to the formula (IVa) 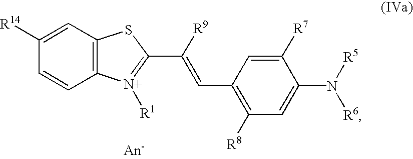
in which
R¹ represents methyl, ethyl, propyl, butyl, pentyl, hexyl, benzyl, cyclohexyl, chloroethyl, cyanomethyl, cyanoethyl, hydroxyethyl, 2-hydroxypropyl, methoxyethyl, ethoxyethyl or a radical of the formula 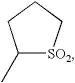
R⁵ and R⁶ independently of one another represent methyl, ethyl, propyl, butyl, pentyl, hexyl, benzyl, cyclohexyl, chloroethyl, hydroxyethyl, 2-hydroxypropyl, methoxyethyl, ethoxyethyl, methoxycarbonylethyl, ethoxycarbonylethyl, acetoxyethyl, phenyl, tolyl or methoxyphenyl or
NR⁵R⁶ represents pyrrolidino, N-methylpiperidino, morpholino or N,N-bis-(2-cyanoethyl)amino,
R⁷ represents hydrogen or
R⁷;R⁵ represent a —(CH₂)₂—, —C(CH₃)—CH₂—C(CH₃)₂— or —O—(CH₂)₂-bridge,
R⁸ represents hydrogen,
R⁹ represents hydrogen,
R¹⁴ represents hydrogen, methyl, methoxy or ethoxy and
An⁻ represents tetrafluoroborate, perchlorate, hexafluorosilicate, hexafluorophosphate, iodide, rhodanide, cyanate, hydroxy acetate, methoxy acetate, lactate, citrate, methane sulphonate, ethane sulphonate, benzene sulphonate, toluene sulphonate, butylbenzene sulphonate, chlorobenzene sulphonate, dodecylbenzene sulphonate or naphthalene sulphonate.

12. An optical data storage medium according to one or more of claims 1 to 5, characterized in that the hemicyanine corresponds to the formula (VII) 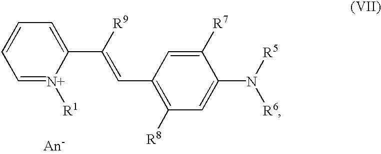
in which
R¹ represents methyl, ethyl, propyl, butyl, pentyl, hexyl, benzyl, cyclohexyl, chloroethyl, cyanomethyl, cyanoethyl, hydroxyethyl, 2-hydroxypropyl, methoxyethyl, ethoxyethyl or a radical of the formula 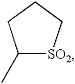
R⁵ and R⁶ independently of one another represent methyl, ethyl, propyl, butyl, pentyl, hexyl, benzyl, cyclohexyl, chloroethyl, cyanoethyl, hydroxyethyl, 2-hydroxypropyl, methoxyethyl, ethoxyethyl, methoxycarbonylethyl, ethoxycarbonylethyl, acetoxyethyl, phenyl, tolyl or methoxyphenyl or
NR⁵R⁶ represents pyrrolidino, N-methylpiperidino or morpholino,
R⁷ represents hydrogen or
R⁷;R⁵ represent a —(CH₂)₂—, —C(CH₃)—CH₂—C(CH₃)₂— or —O—(CH₂)₂-bridge,
R⁸ represents hydrogen,
R⁹ represents hydrogen,
An⁻ represents tetrafluoroborate, perchlorate, hexafluorosilicate, hexafluorophosphate, iodide, rhodanide, cyanate, hydroxy acetate, methoxy acetate, lactate, citrate, methane sulphonate, ethane sulphonate, benzene sulphonate, toluene sulphonate, butylbenzene sulphonate, chlorobenzene sulphonate, dodecylbenzene sulphonate or naphthalene sulphonate.

13. An optical data storage medium according to one or more of claims 1 to 5, characterized in that the hemicyanine corresponds to the formula (VIII) 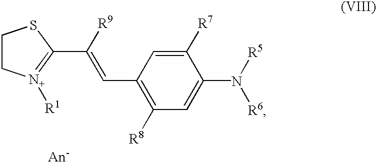
in which
R¹ represents methyl, ethyl, propyl, butyl, pentyl, hexyl, benzyl, cyclohexyl, chloroethyl, cyanomethyl, cyanoethyl, hydroxyethyl, 2-hydroxypropyl, methoxyethyl, ethoxyethyl or a radical of the formula 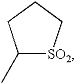
R⁵ and R⁶ independently of one another represent methyl, ethyl, propyl, butyl, pentyl, hexyl, benzyl, cyclohexyl, chloroethyl, cyanoethyl, hydroxyethyl, 2-hydroxypropyl, methoxyethyl, ethoxyethyl, methoxycarbonylethyl, ethoxycarbonylethyl, acetoxyethyl, phenyl, tolyl or methoxyphenyl or
NR⁵R⁶ represents pyrrolidino, N-methylpiperidino or morpholino,
R⁷ represents hydrogen or
R⁷;R⁵ represent a —(CH₂)₂—, —C(CH₃)—CH₂—C(CH₃)₂— or O—(CH₂)₂-bridge,
R⁸ represents hydrogen,
R⁹ represents hydrogen,
An⁻ represents tetrafluoroborate, perchlorate, hexafluorosilicate, hexafluorophosphate, iodide, rhodanide, cyanate, hydroxy acetate, methoxy acetate, lactate, citrate, methane sulphonate, ethane sulphonate, benzene sulphonate, toluene sulphonate, butylbenzene sulphonate, chlorobenzene sulphonate, dodecylbenzene sulphonate or naphthalene sulphonate.

14. An optical data storage medium according to one or more of claims 1 to 5, characterized in that the hemicyanine corresponds to the formula (IX) 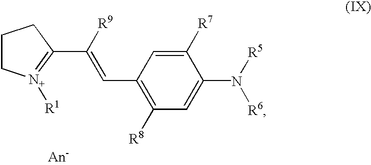
in which
R¹ represents methyl, ethyl, propyl, butyl, pentyl, hexyl, benzyl, cyclohexyl, chloroethyl, cyanomethyl, cyanoethyl, hydroxyethyl, 2-hydroxypropyl, methoxyethyl, ethoxyethyl or a radical of the formula 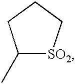
R⁵ and R⁶ independently of one another represent methyl, ethyl, propyl, butyl, pentyl, hexyl, benzyl, cyclohexyl, chloroethyl, cyanoethyl, hydroxyethyl, 2-hydroxypropyl, methoxyethyl, ethoxyethyl, methoxycarbonylethyl, ethoxycarbonylethyl, acetoxyethyl, phenyl, tolyl or methoxyphenyl or
NR⁵R⁶ represents pyrrolidino, N-methylpiperidino or morpholino,
R⁷ represents hydrogen or
R⁷;R⁵ represent a —(CH₂)₂—, —C(CH₃)—CH₂—C(CH₃)₂— or —O—(CH₂)₂-bridge,
R⁸ represents hydrogen,
R⁹ represents hydrogen,
An⁻ represents tetrafluoroborate, perchlorate, hexafluorosilicate, hexafluorophosphate, iodide, rhodanide, cyanate, hydroxy acetate, methoxy acetate, lactate, citrate, methane sulphonate, ethane sulphonate, benzene sulphonate, toluene sulphonate, butylbenzene sulphonate, chlorobenzene sulphonate, dodecylbenzene sulphonate or naphthalene sulphonate.

15. The use of hemicyanines in the information layer of recordable optical data storage media, wherein the hemicyanines have an absorption maximum λₘₐₓ₂ in the range from 420 to 650 nm.

16. The use of hemicyanines in the information layer of recordable optical data storage media, wherein the data storage media are recorded on and read with a blue laser light.

17. A process for producing the optical data storage media according to claim 1, which is characterized in that a preferably transparent substrate, which has optionally already been coated with a reflecting layer, is coated with the hemicyanines, optionally in combination with suitable binders and additives and optionally suitable solvents, and is optionally provided with a reflecting layer, additional intermediate layers and optionally a protective layer or an additional substrate or a top layer.

18. Optical data storage media according to claim 1 which have been recorded on using blue or red, in particular blue light, and especially blue laser light.
